(19) United States
(12) Patent Application Publication
(10) Pub. No.: US 2006/0224871 A1
(43) Pub. Date: Oct. 5, 2006

(54) Wide branch target buffer

(75) Inventor: Thang Minh Tran, Austin, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/095,862

(22) Filed: Mar. 31, 2005

(51) Int. Cl. G06F 9/00

(52) U.S. Cl. 712/239

(57) ABSTRACT

A system comprising a pipeline in which a first plurality of instructions are processed, and a branch prediction module coupled to the pipeline, where the branch prediction module is adapted to predict the outcomes of at least some branch instructions in the first plurality of instructions and in a second plurality of instructions that have not yet been fetched into the pipeline.

### BACKGROUND

Processor systems perform various tasks by processing task instructions within pipelines contained in the processor systems. Pipelines generally are responsible for fetching instructions from a storage unit such as a memory or cache, decoding the instructions, executing the instructions, and then writing the results into another storage unit, such as a register. Pipelines generally process multiple instructions at a time. For example, a pipeline may simultaneously execute a first instruction, decode a second instruction and fetch a third instruction from a cache.

Instructions stored in a cache often comprise conditional branch instructions. Based on a result of a condition embedded within a conditional branch instruction, program flow continues on a first path or a second path following the conditional branch instruction. For example, if the conditional statement is “false,” the instruction following the conditional branch is executed. If the condition is “true,” a branch to an instruction other than the next instruction is performed. Whether the condition is true or false is not known with complete certainty until the conditional branch instruction is executed. Unfortunately, in many cases, the time penalty for executing a conditional branch instruction may be 10 cycles or more. In the meantime, it is not known which instructions to fetch and decode.

An instruction cache also comprises unconditional branch instructions. Unconditional branch instructions are simply branch instructions that do not contain, and thus are not contingent upon, a conditional instruction. Unconditional branch instructions are virtually always assumed to be “true,” meaning that the branch is virtually always taken to an instruction other than the next instruction. The time penalty for decoding an unconditional branch instruction may, in many cases, be 5 cycles or more.

A technique known as branch prediction enhances processing speed by predicting the results of conditional and unconditional branch instructions before the instructions actually are executed. In the case of conditional branch instructions, a prediction is made early on in the pipeline as to whether the condition is true or false. The pipeline begins to process instructions based on this prediction. If the prediction proves to be correct, then the processor has saved time that would otherwise have been wasted waiting for the conditional branch instruction to be executed. Conversely, if the prediction proves to be incorrect, then the wrongly fetched instructions are flushed from the pipeline and the correct instructions are fetched into the pipeline. In the case of unconditional branch instructions, the pipeline begins to process the instructions (i.e., “target instructions”) that usually are processed when executing that particular unconditional branch instruction. The target instructions are determined based on previous executions of that particular instruction (i.e., historical data). In this way, historical data is used to “predict” the target instructions and execution of the unconditional branch instruction is avoided.

In the case of branch prediction for conditional branch instructions, time and power are lost not only in flushing the pipeline, but also in fetching the wrongly fetched instructions from the instruction cache. Further, although accurate branch predictions may increase processor performance in the case of both conditional and unconditional branch instructions, because branch prediction generally takes more than 1 cycle to perform and because instruction fetches are in locked step with branch predictions, the instruction cache fetches unnecessary instructions and transfers them to the pipeline, thus excessively consuming power.

### SUMMARY

The problems noted above are solved in large part by a system comprising a “wide” branch target buffer and a method for using the same. At least one illustrative embodiment is a system comprising a pipeline in which a first plurality of instructions are processed, and a branch prediction module coupled to the pipeline, where the branch prediction module is adapted to predict the outcomes of at least some branch instructions in the first plurality of instructions and in a second plurality of instructions that have not yet been fetched into the pipeline.

Another illustrative embodiment may be a processor comprising a first module adapted to store a plurality of instructions, a second module coupled to the first module and adapted to determine whether a first quantity of instructions in the first module comprises a branch instruction, and to predict the outcome of the branch instruction. The processor also comprises a pipeline coupled to the first module and adapted to process instructions received based on the prediction, where the first quantity of instructions is at least approximately twice a quantity of instructions fetched from the first module per clock cycle.

Yet another illustrative embodiment may be a method comprising fetching a first plurality of instructions for processing in a pipeline and determining whether a second plurality of instructions comprises at least one branch instruction, the second plurality of instructions greater than the first plurality of instructions. If the second plurality of instructions comprises a branch instruction, the method comprises predicting an outcome of the branch instruction. The method also comprises routing the second plurality of instructions based on the prediction.

### BRIEF DESCRIPTION OF THE DRAWINGS

For a detailed description of exemplary embodiments of the invention, reference will now be made to the accompanying drawings in which:

FIG. 1 shows a block diagram of processor comprising a storage unit, a branch target buffer and a pipeline, in accordance with embodiments of the invention;

FIG. 2 shows a detailed version of the processor of FIG. 1, in accordance with a preferred embodiment of the invention;

FIG. 3a shows a set of instructions to be processed by the processor of FIGS. 1 and 2, in accordance with embodiments of the invention;

FIG. 3b shows a state table describing the processing of the instructions in FIG. 3a, in accordance with embodiments of the invention;

FIG. 4 shows a flow diagram that may be used to implement the techniques described below in context of the processor of FIGS. 1 and 2, in accordance with a preferred embodiment of the invention; and

FIG. 5 shows a communication device that may comprise the processor shown in FIGS. 1 and 2, in accordance with embodiments of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein is a processor system that is able to perform branch predictions on branch instructions earlier in time than is possible with other processor systems. By performing branch predictions earlier, instructions that will be skipped and that will not be executed are not fetched. Preventing unnecessary instruction fetches enables the processor system to conserve more power than other processor systems. Also, by performing branch predictions earlier, the processor system is able to predict earlier in time not only which instructions will be skipped, but which instructions will be executed instead. By predicting which instructions will be executed, the processor is able to begin performing those instructions, thus increasing performance.

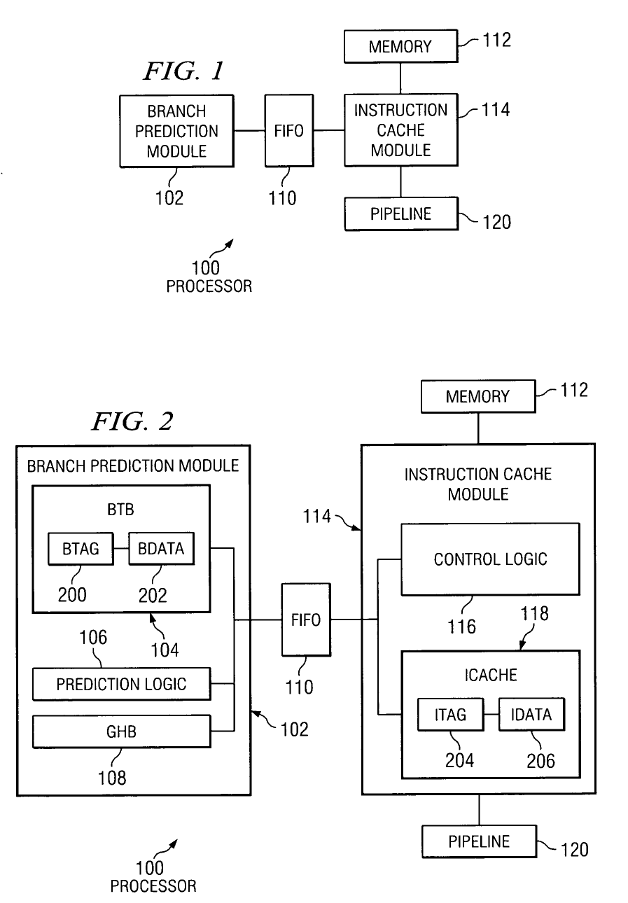

FIG. 1 shows a block diagram of a portion of a processor 100 comprising, among other things, a branch prediction module 102, an instruction cache module 114, a first-in, first-out (FIFO) module 110 situated therebetween, a memory 112 coupled to the instruction cache module 114 and a processing pipeline 120 coupled to the instruction cache module 114.

The branch prediction module 102 stores historical data that describes the behavior of previously-executed branch instructions. For example, for a set of instructions having a single branch instruction, the branch prediction module 102 stores the address of the branch instruction, as well as the address of the instruction that is executed immediately after the branch instruction. The instruction that is executed immediately after the branch instruction may vary, based on whether or not the branch in the branch instruction is taken. If, during previous iterations, the branch usually was not taken, then the branch prediction module 102 stores the address of the instruction succeeding the branch instruction. In some embodiments, the branch prediction module 102 may not store the address of such a succeeding instruction, since in these embodiments, the next address used is the next sequential address which is generated as if there is no branch instruction in the instruction sequence. Thus, a “not-taken” branch instruction and the complete absence of a branch instruction both would take the same path to the next sequential address (e.g., generated by incrementing the previous address). However, if during previous iterations, the branch usually was taken to, for instance, the last instruction in the instruction set, then the branch prediction module 102 stores the address of the last instruction in the instruction set. The address of the instruction executed after the branch instruction is termed the “target address.”

When a set of instructions is processed by the processor 100, the branch prediction module 102 receives the address of the first instruction in the set of instructions. The branch prediction module 102 preferably comprises logic that increments the address of the first instruction, so that the branch prediction module 102 has the address of both the first and second instructions in the instruction set. The branch prediction module 102 then searches its contents to determine whether an address matching either the first or second instructions can be found. If a matching address is found in the branch prediction module 102, then the instruction corresponding to the address is recognized to be a branch instruction, since the module 102 stores only information pertaining to branch instructions. Accordingly, the branch prediction module 102 determines, based on historical data and previous iterations of the particular instruction, the target address of the branch instruction. The branch prediction module 102 transfers the target address to the instruction cache module 114 via the FIFO 110. Generally, if a branch in a branch instruction is taken, the target address is the address of the instruction indicated by the branch instruction. If a branch in a branch instruction is not taken, the target address may be the address of the instruction or, in some embodiments, group of instructions immediately succeeding the branch instruction. This target address may be obtained by, for example, incrementing to the next sequential address (i.e., the next instruction).

The instruction cache module 114 receives the target address and searches its contents in an attempt to find an address that matches the target address. If a matching address is found in the instruction cache module 114, then the instruction that corresponds to that address also is located in the instruction cache module 114. That instruction is extracted from the module 114 and is transferred into the pipeline 120. If a matching address is not found in the module 114, then the instruction is retrieved from the memory 112. Because the branch prediction module 102 processes data (as described above) at a rate higher than the instruction cache module 114, the branch prediction module 102 is effectively able to “look ahead” for pending branch instructions and is able to transfer to the module 114, based on historical data, the target addresses of the instructions that are most likely to be executed after the branch instructions. Looking ahead in this manner avoids the need to unnecessarily fetch and process instructions that will not be executed (i.e., will be flushed from the pipeline 120), thus saving substantial amounts of power and time.

FIG. 2 shows a more detailed view of the processor 100 of FIG. 1. Specifically, FIG. 2 shows the processor 100 comprising the same branch prediction module 102, FIFO 110, instruction cache module 114, memory 112 and pipeline 120 as in FIG. 1. As shown in the figure, the instruction cache module 114 further comprises a control logic 116 and an instruction cache (icache) 118, which in turn comprises an instruction address tag random access memory (Tag RAM or ITAG) 204 coupled to an instruction data RAM (IDAT) 206. The IDAT 206 may be of any suitable size and may store instructions that are to be executed by the processor 100 via insertion into the pipeline 120. These instructions may be obtained, for example, from the memory 112. The ITAG 204 stores tag addresses of instructions that are stored in the IDAT 206. The control logic 116 is any suitable circuit logic capable of controlling various functions of the instruction cache module 114.

The branch prediction module 102 comprises a branch target buffer (BTB) 104 and a prediction logic 106. The BTB 104, in turn, comprises an address tag random access memory (Tag RAM or BTAG) 200 coupled to a data RAM (BDATA) 202. The prediction logic 106 controls various aspects of the branch prediction module 102. The branch prediction module 102 also comprises a global history buffer (GHB) 108, the purpose of which is described further below.

In at least some embodiments, the processor 100 processes groups of instructions at a time. For example, in a preferred embodiment, the instruction cache module 114 processes 64 bits of instructions (e.g., 4 instructions of 16 bits each) at a time, while the branch prediction module 102 processes addresses representing 128 bits of instructions (e.g., 8 instructions of 16 bits each) at a time. In this way, the module 102 is effectively able to “look ahead” at upcoming branch instructions that have not yet been processed by the pipeline 120 or that have not even been fetched by the pipeline 120 from the module 114. As such, the module 102 is able to send, based on branch predictions, target addresses to the module 114, thus avoiding the unnecessary fetching, processing and/or flushing of branched-over instructions.

The branch predictions themselves are based on historical data. If during previous iterations, a particular branch instruction had a branch that was consistently taken, then the BTB 104 may comprise prediction data bits (i.e., as in bimodal prediction) that indicate that the branch is likely to be taken. Conversely, if during previous iterations, the branch was rarely taken, then the BTB 104 may comprise data bits that indicate that the branch is not likely to be taken. In at least some embodiments, there may exist four groups of prediction data bits: “0 0,” indicating that a branch is very unlikely to be taken; “0 1,” indicating that a branch is somewhat unlikely to be taken; “1 0,” indicating that a branch is somewhat likely to be taken; and “1 1,” indicating that a branch is very likely to be taken. Also, in some embodiments, prediction may be performed using global history prediction in lieu of bimodal prediction, which global history prediction may be performed by a separate module GHB 108 and which global history prediction is known in industry. Further information on global history prediction is found in “Dynamic Classification of Conditional Branches in Global History Branch Prediction,” U.S. Pat. No. 6,502,188, which is incorporated herein by reference.

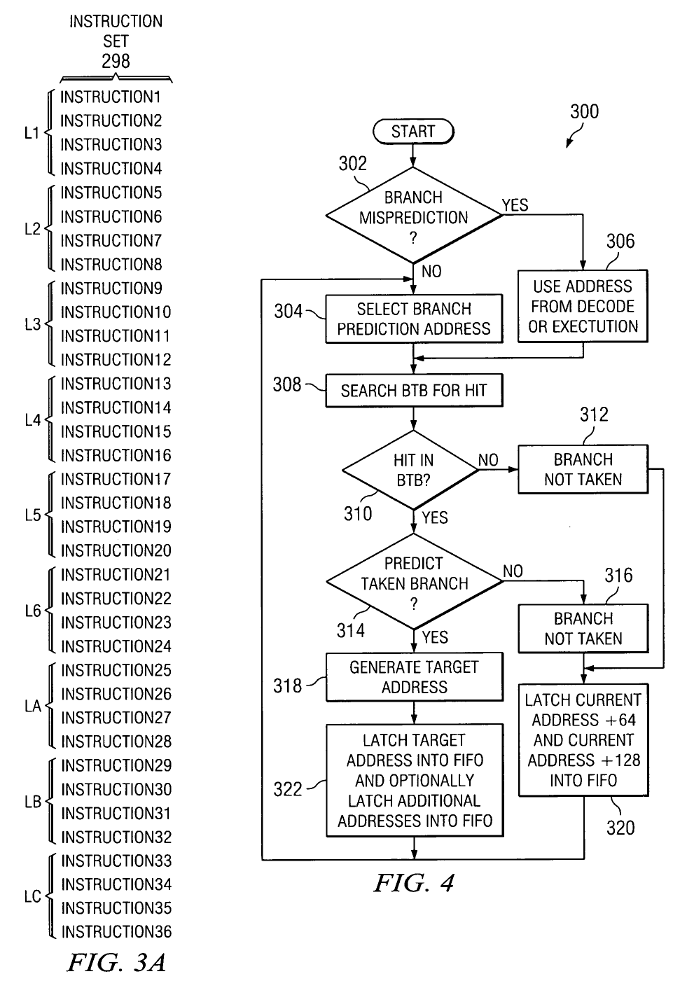

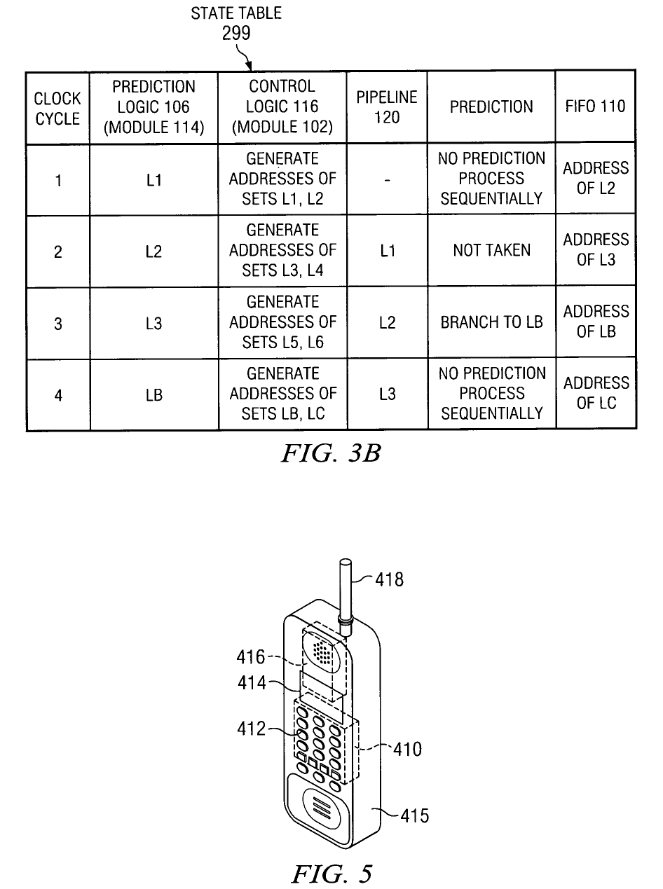

The operation of the branch prediction module 102 and the instruction cache module 114 is best described in context of an illustrative set of instructions. Accordingly, an illustrative instruction set 298 is shown in FIG. 3a. The instruction set 298 comprises instructions 1-36. The instructions are divided into groups of four. Each group is labeled as L1-L6 or LA-LC. Each group preferably comprises 64 bits of instructions. A state table 299 is shown in FIG. 3b that describes the contents of the module 114, pipeline 120, module 102, FIFO 110 and the prediction of the module 102 during each clock cycle as the instruction set 298 is processed. Although the following discussion is presented in context of the instruction set 298, the scope of disclosure is not limited to the processing of any particular type of instruction set or any particular arrangement of instructions found therein.

Referring simultaneously to FIGS. 2, 3a and 3b, during a first clock cycle, each of the prediction logic 106 and the control logic 116 is provided with the same initial program counter (or starting address). This starting address generally is understood to be the address of instruction 1. The architecture of the branch prediction module 102 (e.g., buses, memory widths, etc.) is of a width such that in a given unit of time, the branch prediction module 102 processes the addresses of a greater quantity of instructions (e.g., 128 bits of instructions) than the quantity of instructions processed by the instruction cache module 114 (e.g., 64 bits). Accordingly, as shown in clock cycle 1 of FIG. 3b, while the module 114 (i.e., the control logic 116) begins processing the instructions in set L1, the module 102 (i.e., the prediction logic 106) generates the addresses of the instructions in sets L1 and L2. In processing the instructions in set L1, the control logic 116 searches the ITAG 204 for addresses that match those of the instructions in L1. If matching addresses are found, then instructions corresponding to the matching addresses (e.g., instructions 1-4) may be found in the IDAT 206. These instructions are fetched from the IDAT 206 and are inserted into the pipeline 120 for processing. If there are no matching addresses or one or more of the instructions cannot be found in the IDAT 206, then the instructions may be retrieved from the memory 112. In some cases, fetching instructions from the memory 112 may take several cycles. Thus, the module 114 will stall and wait for instructions from the memory 112 while branch prediction (performed by the module 102) proceeds as described below. Addresses generated by the module 102 are latched into the FIFO.

Because no prediction can yet be made in clock cycle 1 by the prediction logic 106, the prediction logic 106 transfers the address of the first instruction in set L2 (i.e., instruction 5) to the FIFO 110 which, in turn, transfers the address to the control logic 116. This address is the “target address.”

As shown in clock cycle 2 of state table 299, the module 114 (i.e., control logic 116) begins searching the ITAG 204 for addresses matching the addresses of instructions in set L2, as previously described. Based on whether the addresses match those in the ITAG 204, the instructions may be fetched from either the IDAT 206 or the memory 112. Also in clock cycle 2, the pipeline 120 begins processing the instructions in set L1 (i.e., Instructions 1-4). Further, in clock cycle 2, the module 102 (i.e., the prediction logic 106) begins generating the addresses of the instructions of sets L3 and L4. Although not shown in FIG. 3b, the prediction logic 106 also searches the BTAG 200 for addresses matching the addresses of the instructions in sets L1 and L2, since the addresses were generated during the previous clock cycle. If an address in the BTAG 200 matches an address of an instruction in sets L1 or L2, then that instruction is recognized as a branch instruction. Accordingly, a corresponding target address may be found in the BDATA 202. The prediction logic 106 retrieves the target address from the BDATA 202 and transfers the target address to the module 114 via the FIFO 110.

As shown in clock cycle 2 of table 299, the prediction logic 106 makes a prediction of “not taken,” meaning that the logic 106 recognizes one of the instructions in sets L1 or L2 to be a branch instruction and, upon searching the BTB 104, determines that this branch is usually not taken. Thus, the target address is simply the address of the instruction following the branch instruction (i.e., a sequential address increment is used for the next instruction). For example, if the logic 106 determines that instruction 8 is a branch instruction, the logic 106 searches the BTAG 200 for an address that matches the address of instruction 8. Because instruction 8 is a branch instruction, a match is found in the BTAG 200. Based on previous iterations, the prediction logic 106 has determined that instruction 9 is the instruction most likely to be executed next. Thus, the logic 106 transfers the address of instruction 9 (i.e., the target address) to the module 114 via the FIFO 110. As shown in clock cycle 2, the FIFO 110 contains the address of set L3 (i.e., instruction 9). Note that, if the branch instruction is, for instance, instruction 7, then the next sequential instruction is instruction 8. However, the sequential fetch address may increment by 64 bits, thus causing instruction 9 to be the next instruction

As shown in clock cycle 3 of table 299, the control logic 116 receives the target address from the FIFO 110 and begins searching the ITAG 204 for an address matching the target address. If the address is found, then the instruction 9 (i.e., set L3) is fetched from the IDAT 206 and transferred into the pipeline 120. Otherwise, the instruction 9 (or set L3) is retrieved from the memory 112. Also in clock cycle 3, the pipeline 120 begins to process the instructions in set L2. Further in clock cycle 3, the module 102 (i.e., the prediction logic 106) begins generating the addresses of the instructions in sets L5 and L6. Although not specifically shown in table 299, the logic 106 also searches the BTAG 200 for addresses matching the addresses of the instructions in sets L3 and L4, since the addresses were generated during the previous clock cycle. If an address in the BTAG 200 matches an address of an instruction in sets L3 or L4, then that instruction is recognized as a branch instruction. Accordingly, a corresponding target address may be found in the BDATA 202. The prediction logic 106 retrieves the target address from the BDATA 202 and transfers the target address to the module 114 via the FIFO 110.

As shown in clock cycle 3 of table 299, the prediction logic 106 makes a prediction of “taken” to instruction set LB, meaning that the logic 106 recognizes one of the instructions in sets L3 or L4 to be a branch instruction and, upon searching the BDATA 202, determines that this branch is usually taken to instruction 29 (i.e., set LB). Thus, the target address is the address of instruction 29. The logic 106 transfers the address of instruction 29 (i.e., the target address) to the module 114 via the FIFO 110. As shown in clock cycle 3, the FIFO 110 contains the address of set LB (i.e., instruction 29).

As shown in clock cycle 4 of table 299, the control logic 116 receives the target address for LB from the FIFO 110 and begins searching the ITAG 204 for an address matching the target address. If the address is found, then the instruction 29 is fetched from the IDAT 206 and inserted into the pipeline 120. Otherwise, the instruction 29 is retrieved from the memory 112. Also in clock cycle 4, the pipeline 120 begins to process the instructions in set L3. Because the pipeline 120 has already begun to process instructions in set L3 in clock cycle 4, the pipeline 120 must be flushed or partially invalidated (e.g., if the taken branch instruction is instruction 11, then instruction 12 would be invalidated while instructions 9-11 are valid instruction for pipeline execution) to remove these instructions prior to inserting instruction 29 into the pipeline 120. The instructions in set L3 that have not yet been inserted into the pipeline 120 may be invalidated by the control logic 116.

Further in clock cycle 4, the module 102 (i.e., the prediction logic 106) begins generating the addresses of the instructions in sets LB and LC in order to detect branch instructions in sets LB and LC during the next clock cycle. However, in clock cycle 4, because a branch has been taken and several instruction sets (i.e., portions of set L3 and all of sets L4, L5, L6 and LA) have been skipped, the addresses for which the prediction logic 106 has been searching in the BTAG 200 (i.e., addresses of instructions in sets L5 and L6) are no longer relevant. As such, the logic 106 does not perform a prediction in clock cycle 4, but instead allows program flow to continue sequentially by sending the address of instruction set LC (i.e., address of instruction 33) to the module 114 via FIFO 110. In embodiments where the sets (e.g., L1, L2, etc.) comprise 64 bits, such sequential processing comprises negating the 4 least significant bits and incrementing a current address by 64 each time a new target address is sent to the module 114 via the FIFO 110. Thus, since in clock cycle 3 the address of LB (i.e., instruction 29) was sent to the module 114 via the FIFO 110, incrementing the address of LB (i.e., instruction 29) by 64 produces the address of LC (i.e., instruction 33) that is sent to the module 114 via the FIFO 110 in clock cycle 4.

FIG. 4 shows a flow diagram of a method 300 that may be used to implement the processor 100 described above. The method 300 may begin by determining whether the previous branch instruction had a branch misprediction (block 302). If there was a branch misprediction, then the address obtained by decoding or execution the previous branch instruction is used (block 306). However, if there was no misprediction, then the method comprises selecting a branch prediction address (block 304).

The method further comprises searching the BTB 104 and, more specifically, the BTAG 200 for an address that matches one or more addresses currently being processed (block 308). For example, referring to FIG. 3a, if sets L1 and L2 are being processed by the branch prediction module 102, then in some embodiments, the method 300 comprises searching the BTAG 200 for addresses matching those of the instructions in sets L1 and L2. The method 300 continues further in block 310 by determining whether there is a hit (i.e., matching address) in the BTB 104 (i.e., the BTAG 200). If there is no hit, meaning that there are no matching addresses, then no branch is taken (block 312), and processing of instructions continues sequentially by incrementing the current address by 64 and latching this address into the FIFO, as well as by incrementing the current address by 128 and latching this address into the FIFO 110 as well (block 320). However, if a matching address is indeed found in the BTAG 200 (block 310), then the method 300 comprises determining whether or not a branch is likely to be taken (block 314). If the matching address found in the BTAG 200 refers to an address stored in the BDATA 202 that indicates no branch is likely to be taken and processing continues sequentially, then no branch is taken (block 316), and the branch prediction module 102 provides the instruction cache module 114 with the address of the next sequential instruction or set(s) of instructions which, in some embodiments, is/are obtained by incrementing the current address by 64 and by 128 and further by latching these addresses into the FIFO 110 (block 320). Thus, continuing with the above example, in block 320, the address of L2 (i.e., current address+64) and the address of L3 (i.e., current address+128) are latched into the FIFO 110. Thus, the FIFO 110 contains addresses for L1, L2 and L3. The BTB 104, however, only requires the addresses of L1 and L3.

However, if the branch is predicted to be taken (block 314), then the method 300 comprises generating or retrieving a target address (block 318) and latching the target address (and optionally additional addresses as described below) into the FIFO 110 (block 322). In at least some embodiments, the target address is obtained from the BDATA 202 and forwarded to the instruction cache module 114 via the FIFO 110. The target address is indicative of the instruction that, based on historical data stored in the BTB 104, should be processed next by the pipeline 120. When the target address is received by the instruction cache module 114, the control logic 116 uses the address to fetch the instruction either from the IDAT 206 or from the memory 112 and subsequently transfers the instruction into the pipeline 120 for processing. In at least some embodiments, during the course of instruction decoding and execution by the pipeline 120, the actual results of branch instructions (i.e., branch taken or not taken) may be written to the BTB 104 for future reference during branch predictions (such as by bimodal prediction or global history prediction, described further below).

Continuing with the example above, for block 322, if the branch is in L2, then the address of L2 (i.e., current address+64) and the target address may be latched into the FIFO 110. Thus, the FIFO 110 comprises the addresses of L1, L2 and the target address. The BTB 104 only requires the address of L1 and the target address. However, if the branch is in L1, then only the target address is latched into FIFO 110. Thus, the FIFO 110 comprises the address of L1 and the target address. The BTB 104 only requires the address of L1 and the target address.

In this way, by detecting the presence of branch instructions that are to be processed by the pipeline 120 before the instructions are fetched from instruction cache 114, by predicting the outcomes of such instructions, and further by entering instructions into the pipeline 120 or skipping/invalidating the instructions altogether based on the predicted outcomes, the processor 100 prevents the wasteful fetching of instructions from cache 114 and further prevents processing of invalid instructions by the pipeline 120. Thus, the processor 100 is able to save a substantial amount of time and power in comparison to other processors.

FIG. 5 shows an illustrative embodiment of a system comprising the features described above. The embodiment of FIG. 5 comprises a battery-operated, wireless communication device 415. As shown, the communication device 415 includes an integrated keypad 412 and a display 414. The processor 100 may be included in an electronic package 410 which may be coupled to keypad 412, display 414 and a radio frequency (RF) transceiver 416. The RF circuitry 416 preferably is coupled to an antenna 418 to transmit and/or receive wireless communications. In some embodiments, the communication device 415 comprises a cellular (e.g., mobile) telephone.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a pipeline in which a first plurality of instructions are processed; and
a branch prediction module coupled to the pipeline and adapted to predict the outcomes of at least some branch instructions in said first plurality of instructions and in a second plurality of instructions that have not yet been fetched into the pipeline.

2. The system of claim 1, wherein the system comprises at least one of a battery-operated device and a wireless device.

3. The system of claim 1, wherein the branch prediction module predicts the outcomes of the at least some branch instructions based on data stored in the branch prediction module, said data indicative of outcomes of previous executions of the at least some branch instructions.

4. The system of claim 1 further comprising an instruction cache module coupled to the branch prediction module, said instruction cache module adapted to:
store at least some of the first plurality of instructions and the second plurality of instructions; and
based on a target address received from the branch prediction module, retrieve a target instruction from the first plurality of instructions or the second plurality of instructions; and
transfer the target instruction to the pipeline.

5. The system of claim 4, wherein the branch prediction module processes, in one clock cycle, the addresses of twice a quantity of instructions processed by the instruction cache module.

6. The system of claim 5, wherein the branch prediction module processes the addresses of 128 bits of instructions while the instruction cache module processes 64 bits of instructions.

7. A processor, comprising:
a first module adapted to store a plurality of instructions;
a second module coupled to the first module and adapted to determine whether a first quantity of instructions in the first module comprises a branch instruction, and to predict the outcome of the branch instruction; and
a pipeline coupled to the first module and adapted to process instructions received based on said prediction;
wherein the first quantity of instructions is at least approximately twice a quantity of instructions fetched from the first module per clock cycle.

8. The processor of claim 7, wherein the second module predicts the outcome of the branch instruction while the branch instruction is located in the first module.

9. The processor of claim 7, wherein the second module predicts the outcome of the branch instruction based on historical data stored in the second module, said historical data indicative of the address of an instruction executed after the branch instruction during a previous iteration.

10. The processor of claim 7, wherein the second module compares, in about one clock cycle, a first plurality of addresses stored in the second module to a second plurality of addresses, the second plurality of addresses corresponding to the first quantity of instructions.

11. The processor of claim 7, wherein the first quantity of instructions comprises about 128 bits.

12. The processor of claim 7, wherein the first module invalidates an instruction based on said prediction.

13. The processor of claim 7, wherein the first module receives a target address from the second module based on said prediction and, based on the target address, fetches a target instruction from a storage device coupled to the first module.

14. The processor of claim 13 further comprising a first in, first out (FIFO) module coupled between the first and second modules, said FIFO adapted to store target addresses generated by the second module while the first module fetches said target instruction from the storage device.

15. A method, comprising:
fetching a first plurality of instructions for processing in a pipeline;
determining whether a second plurality of instructions comprises at least one branch instruction, the second plurality of instructions greater than the first plurality of instructions;
if the second plurality of instructions comprises a branch instruction, predicting an outcome of the branch instruction; and
routing the second plurality of instructions based on said prediction.

16. The method of claim 15, wherein routing the second plurality of instructions comprises skipping at least some of the second plurality of instructions.

17. The method of claim 15, further comprising invalidating an instruction that has not entered the pipeline.

18. The method of claim 15, wherein the second plurality of instructions is approximately twice as large as the first plurality of instructions.

19. The method of claim 15, wherein fetching comprises fetching approximately 64 bits of data.

20. The method of claim 15, wherein the second plurality of instructions comprises 128 bits of data.

21. The method of claim 15, wherein predicting the outcome comprises one of generating a target address or retrieving a target address.
